(19) United States
(12) Patent Application Publication
(10) Pub. No.: US 2020/0303756 A1
(43) Pub. Date: Sep. 24, 2020

(54) Deployment Device and Methods for an Oxygen-Barrier-Based Surface Benthic Microbial Fuel Cell

(71) Applicant: The United States of America as represented by the Secretary of the Navy, San Diego, CA (US)

(72) Inventors: Andrew M. Higier, San Diego, CA (US); Kenneth E. Richter, San Diego, CA (US); Lewis Hsu, San Diego, CA (US); David B. Chadwick, San Diego, CA (US)

(73) Assignee: The United States of America as represented by the Secretary of the Navy, San Diego, CA (US)

(21) Appl. No.: 16/140,917

(22) Filed: Sep. 25, 2018

(51) Int. Cl. H01M 8/16; H01M 8/04; H01M 8/0273

(52) U.S. Cl. CPC H01M 8/16; H01M 2250/20; H01M 8/0273; H01M 8/04

(57) ABSTRACT

A deployment device involving a frame and a deployment mechanism operably coupled with the frame and configured to perform at least one of deploy and retract a plurality of surface benthic microbial fuel cell systems in at least one manner of manually, autonomously, and semi-autonomously.

### FEDERALLY-SPONSORED RESEARCH AND DEVELOPMENT

The United States Government has ownership rights in the subject matter of this invention. Licensing inquiries may be directed to Office of Research and Technical Applications, Space and Naval Warfare Systems Center, Pacific, Code 72120, San Diego, Calif., 92152; telephone (619) 553-5118; email: ssc_pac_t2@navy.mil. Reference Navy Case No. 103,686.

### BACKGROUND OF THE INVENTION

### Technical Field

The present disclosure relates to technologies for continuous power generation. Particularly, the present disclosure relates to technologies for continuous power generation in a marine, freshwater or brackish environment.

### Description of the Related Art

In the related art, for benthic microbial fuel cell (BMFC) anodes, operation under anaerobic conditions is challenging as the functionality thereof is adversely affected by the presence of oxygen, thereby adversely affecting the microbiology and chemistry that should, otherwise, be driving power production. Related art installation methods of these large-scale anodes of BMFCs under ocean floor sediment is difficult, time consuming, and almost impossible in very deep water. Thus, the related art deployment methods involve challenges in attempting to deploy large surface anode systems, such as limited diver-assisted deployments, wherein the weight and unwieldy nature of a surface anode render the effort difficult and cumbersome. Additionally, small scale related art BMFC systems are limited by their active surface area and will produce very low power. Therefore, a need exists for systems and methods that facilitate deployment of BMFC systems for providing a renewable energy in any marine environment.

### SUMMARY OF THE INVENTION

The present disclosure generally involves a deployment device, comprising: a frame; and a deployment mechanism operably coupled with the frame and configured to perform at least one of deploy and retract a plurality of surface benthic microbial fuel cell systems in at least one manner of manually, autonomously, and semi-autonomously.

### BRIEF DESCRIPTION OF THE DRAWINGS

The above, and other, aspects and features of several embodiments of the present disclosure will be more apparent from the following Detailed Description of the Invention as presented in conjunction with the following several figures of the Drawings.

FIG. 1 is a diagram illustrating a perspective view of a surface benthic microbial fuel cell (SBMFC) system, comprising an oxygen-barrier layer and a BMFC system, the SBMFC system in an unfurled state, e.g., ready for furling into a transportable state, in accordance with an embodiment of the present disclosure.

FIG. 2 is a diagram illustrating a perspective view of an SBMFC system, comprising an oxygen-barrier layer and a BMFC system, the SBMFC system in a rolled or furled state, e.g., ready for transport and prior to deployment, in accordance with an embodiment of the present disclosure.

FIG. 3 is a diagram illustrating a perspective view of a deployment device accommodating a plurality of SBMFC systems, the plurality of SBMFC systems being ready to deploy, in accordance with an embodiment of the present disclosure.

FIG. 4 is a diagram illustrating a perspective view of a deployment device, as shown in FIG. 3, comprising a deployment mechanism, the plurality of SBMFC systems being fully deployed, in accordance with an embodiment of the present disclosure.

FIG. 5 is a diagram illustrating a perspective view of a deployment device, as shown in FIG. 3, comprising a deployment mechanism, as shown in FIG. 4, in accordance with an embodiment of the present disclosure.

FIG. 6 is a flow diagram illustrating a method of fabricating an SBMFC system, in accordance with an embodiment of the present disclosure.

FIG. 7 is a flow diagram illustrating a method of fabricating a deployment device for deploying a plurality of SBMFC systems, in accordance with an embodiment of the present disclosure.

FIG. 8 is a flow diagram illustrating a method of deploying a plurality of SBMFC systems by way of a deployment device, in accordance with an embodiment of the present disclosure.

FIG. 9 is a diagram of a SBMFC system in a deployed configuration having a flat hose to be pressurized to inflate for deployment.

FIGS. 10A and 10B show a diagram of a SBMFC system in a deployed configuration and in a rolled configuration, respectively.

FIG. 11 shows a diagram of a SBMFC system wherein the deployment device may further comprise a retraction mechanism/winch.

Corresponding reference numerals or characters indicate corresponding components throughout the several figures of the Drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood, elements that are useful or necessary in commercially feasible embodiments are often not depicted in order to facilitate a less obstructed view of these various embodiments of the present disclosure.

### DETAILED DESCRIPTION OF THE INVENTION

In order to address many of the related art challenges, the present disclosure generally involves a deployment device having a deployment mechanism, a method of fabricating the deployment device, and a method of operating the deployment device for deploying an oxygen-barrier-based SBMFC. The present disclosure also generally involves an SBMFC system, comprising a BMFC, that is configured to facilitate disposal of a plurality of anodes on a sediment surface, e.g., without requiring burial under the sediment surface, wherein the plurality of anodes is configured to operate under anaerobic conditions. The systems, devices, and methods of the present disclosure are implementable in any aquatic environment, including, but not limited to, marine environments, such as ocean water and sea water, fresh water, and a brackish environments.

In embodiments of the present disclosure, the deployment device, comprising the deployment mechanism, and corresponding methods are implemented for use with an SBMFC comprising an oxygen-barrier layer disposed between the anode of a BMFC for maintaining an anaerobic condition and a surrounding water column, the surrounding water column being inherently aerobic. The oxygen-barrier layer maintains the anode under an anaerobic condition without requiring burial. By example only, the oxygen-barrier layer comprises a material which separates the anode from the water column, rather than relying on marine sediment itself to do so as in the related art. This oxygen-barrier layer allows the anodes to operate effectively while disposed on the sediment surface, rather than in the sediment, e.g., without burial, or by eliminating the burial requirement for the plurality of anodes.

While this SBMFC system of the present disclosure has a configuration that is believed to be an advancement in BMFC technology, deployment of the SBMFC system is also critical, e.g., automatic, semi-automatic, and/or other mechanized deployment on a large scale, to obtain a usable power level. To avoid the risk and costs associated with related art diver deployments, the subject matter of the present disclosure involves a deployment device, comprising a deployment mechanism, and corresponding methods for a large-scale deployment of a plurality of SBMFC systems. This deployment device involves features for facilitating assembly, transport, loading deployment, and even retraction of large SBMFC systems which do not require the burial of the BMFC anodes.

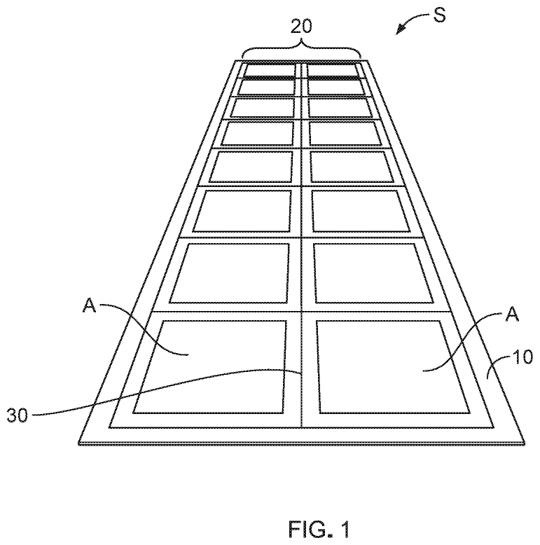

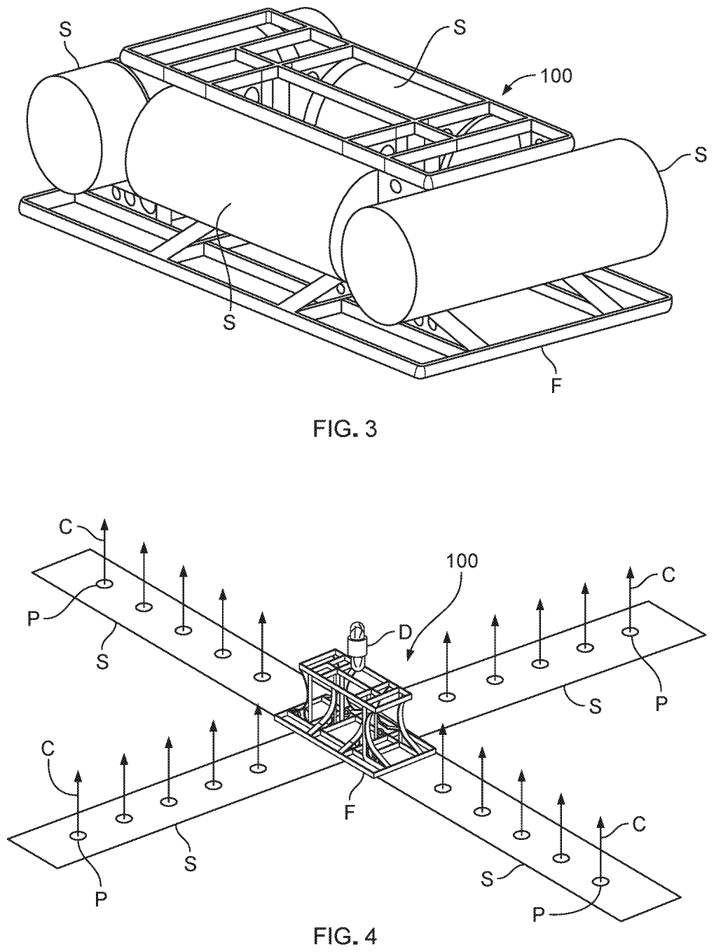

Referring to FIG. 1, this diagram illustrates, in a perspective view, an SBMFC system S, comprising: an oxygen-barrier layer 10; and a BMFC system 20, having a plurality of anodes A, such as “surface” anodes, e.g., anodes disposable on the sediment surface, disposed in relation to, e.g., on, the oxygen-barrier layer 10, the SBMFC system S in an unfurled state, e.g., ready for furling into a transportable state, in accordance with an embodiment of the present disclosure. The SBMFC system S comprises a power output that is scalable as a function of the anode's area. Although the anode A, in conjunction with the oxygen-barrier layer 10, operates without burial thereof, to obtain a usable amount of power, a large-scale SBMFC system S is automatically deployed by a deployment device 100 (FIG. 3) of the present disclosure.

Still referring to FIG. 1, the SBMFC system S is configured to roll or furl into, and to unroll or unfurl from, the deployment device 100. The SBMFC system S is further configured to unroll or unfurl, e.g., automatically, from the deployment device 100 upon contacting the sediment surface under the marine environment, e.g., the ocean floor, whereby the surface anodes unroll or unfurl. In this manner, a plurality of the SBMFC systems S, carrying a large SBMFC surface area, e.g., a total anode surface in a range of approximately 25 ft² to approximately 100 ft², are easily and compactly loadable onto a vessel for automatic deployment. The SBMFC system S further comprises a circuit 30 configured to electrically couple the plurality of anodes A.

Still referring to FIG. 1, the SBMFC system S is operable by way of a large number of anodes A, e.g., in a range of approximately 4 anodes to approximately 16 anodes, disposed in relation to the oxygen-barrier layer 10, e.g., on the oxygen-barrier layer 10. By example only, the oxygen-barrier layer 10 comprises a rubber mat, such as an impermeable ethylene propylene diene monomer (EPDM) rubber mat and any other oxygen-impermeable material layer. The plurality of anodes A are electrically coupled together and are, thus, configured to increase overall power output of the SBMFC system S. In addition, by using a plurality of small anodes, wherein the plurality of anodes A comprises a large number of anodes, such as in a range of approximately 4 anodes to approximately 16 anodes, e.g., in a preferred range of approximately 4 anodes to approximately 10 anodes, and wherein the plurality of anodes A are electrically isolated, and whereby failure of the SBMFC system S is preventable. The SBMFC system S overcomes many challenges in the related art, such as the failure of one anode A causing failure or remaining anodes A.

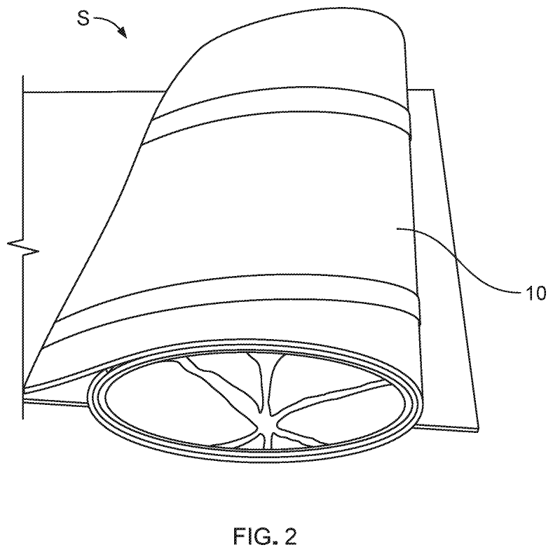

Referring to FIG. 2, this diagram illustrates, in a perspective view, an SBMFC system S, comprising: an oxygen-barrier layer 10; and a BMFC system 20, having a plurality of anodes A, disposed in relation to, e.g., on, the oxygen-barrier layer 10, the SBMFC system S in a rolled or furled state, e.g., ready for transport and prior to deployment, in accordance with an embodiment of the present disclosure. Once the plurality of anodes A is disposed in relation to, e.g., on, the oxygen-barrier layer 10 and is electrically coupled with the circuit (not shown), the SBMFC system S can be rolled or furled. Rolling or furling the SBMFC system S optimizes its size and reduces its complexity, thereby facilitating its transport and loading in relation to the deployment device 100 as well as in relation to the automatic or semi-automatic deployment thereof.

Referring to FIG. 3, this diagram illustrates, in a perspective, a deployment device 100 for deploying a plurality of SBMFC systems S, the plurality of SBMFC systems S being ready to deploy, in accordance with an embodiment of the present disclosure. The deployment device 100 comprises a frame F. By example only, once a plurality of SBMFC systems S, each SBMFC system S comprising a BMFC system 20 having a plurality of anodes A, is rolled or furled, the plurality of SBMFC systems S are readily disposable in relation to the deployment device 100. In accordance with an embodiment of the present disclosure, the deployment device 100 accommodates up to approximately four rolled or furled SBMFC systems S, wherein each SBMFC systems S comprises a length in a range of up to approximately thirty meters (30 m). Once the plurality of SBMFC systems S are rolled and loaded in relation to the deployment device 100, the plurality of SBMFC systems S are easily transportable to a specific location and dropped or lowered into a marine environment.

Referring to FIG. 4, this diagram illustrates, in a perspective, a deployment device 100, as shown in FIG. 3, comprising a deployment mechanism D, the plurality of SBMFC systems S being fully deployed, in accordance with an embodiment of the present disclosure. The SBMFC systems S further comprises a corresponding plurality of cathodes C. The plurality of SBMFC systems S, fully deployed, has an overall power output in a range of approximately five-hundred milliwatts (500 mW) to approximately eight-hundred milliwatts (800 mW). However, the overall power output may vary as a function of the materials used in fabricating the plurality of SBMFC systems S; and any such variations in overall power output are also encompassed by the present disclosure. The overall power output of the plurality of SBMFC systems S far exceeds that of any one SBMFC systems S. Once the deployment device 100 reaches or “hits” the marine sediment surface, e.g., an ocean floor, the plurality of SBMFC systems S unrolls or unfurls, thereby commencing sustainable power production.

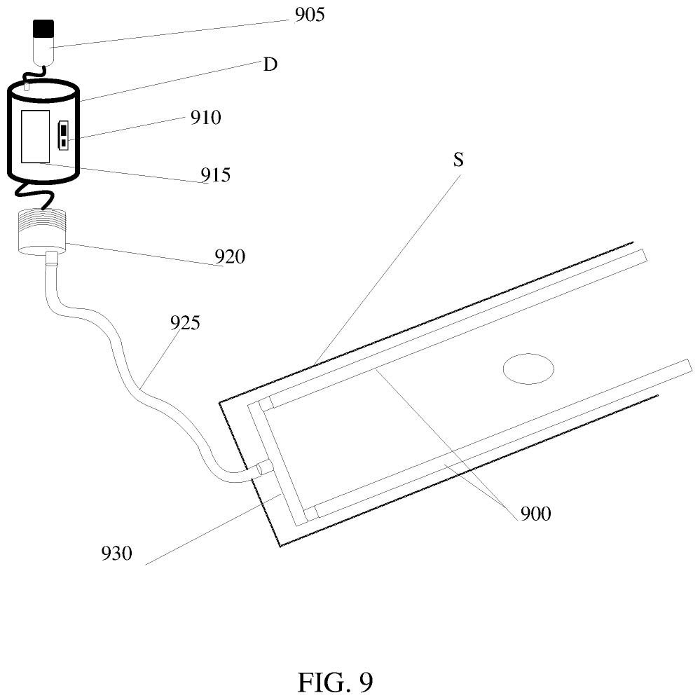

Still referring to FIG. 4, the cathodes C are indicated by vertical arrows and extend from an upper surface of the oxygen-barrier layer 10 (visible in FIG. 2), e.g., comprising at least one of a rubber material mat and any other impermeable material. Openings P facilitate pass-through for electronic wiring and coupling the electrical wiring with at least the cathodes C. In the SBMFC systems S, the plurality of anodes A (visible in FIG. 1) and the corresponding plurality of cathodes C are coupled together via an electronics circuit (visible in FIGS. 9-11). In an embodiment, an anode wiring (not shown) is disposed through the opening P to an upper surface of the oxygen-barrier layer 10 and coupled with the electronic circuit, wherein the electronic circuit is disposed at, or otherwise in relation to, the opening P for facilitating energy harvesting. In another embodiment, a cathode wiring (not shown) may pass through an opening P and to a bottom surface of the oxygen-barrier layer 10, wherein the electronic circuit is disposed thereunder. In yet another embodiment, the anode wiring and the cathode wiring are coupled with a main electronics package (visible in FIGS. 9-11) disposed in relation to at least one of the oxygen-barrier layer 10 and the frame F, wherein the anode wiring and the cathode wiring are disposable therealong. The deployment mechanism D comprises a buoyant structure, such as a buoy, configured to remotely and/or automatically trigger release and/or retraction of a plurality of systems S. The deployment mechanism D is farther configured to perform at least one of: receive, store, and transmit telemetry data; and indicate position for retrieval of the plurality of systems S.

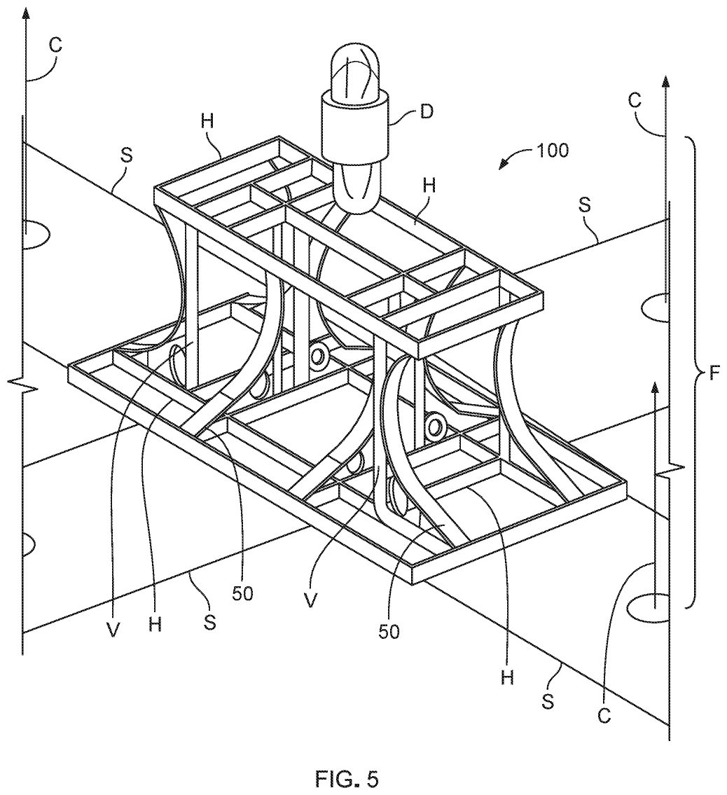

Referring to FIG. 5, this diagram illustrates, in a perspective, a deployment device 100, as shown in FIG. 3, comprising a deployment mechanism D, as shown in FIG. 4, the plurality of SBMFC systems S fully deployed, in accordance with an embodiment of the present disclosure. The deployment device 100 comprises: a frame F configured to accommodate a plurality of SBMFC systems S; and a deployment mechanism D operably coupled with the frame F. The frame F comprises a plurality of horizontal members H, vertical members V, and curved members 50, arranged and coupled together in any configuration that accommodates the plurality of SBMFC systems S.

Referring back to FIGS. 3-5, the deployment device 100 is configured to deploy and bury the plurality of SBMFC systems S, in accordance with an alternative embodiment of the present disclosure. Divers may manually dispose the deployment device 100 in a marine environment and manually deploy the plurality of SBMFC systems S therefrom, in accordance with yet another alternative embodiment of the present disclosure. A remotely operated vehicle (ROV) may robotically dispose the deployment device 100 in a marine environment and robotically deploy the plurality of SBMFC systems S therefrom, in accordance with yet a further alternative embodiment of the present disclosure. However, these alternative embodiments may involve further considerations, such as deployment location, and deployment depth, logistics, cost, and risk.

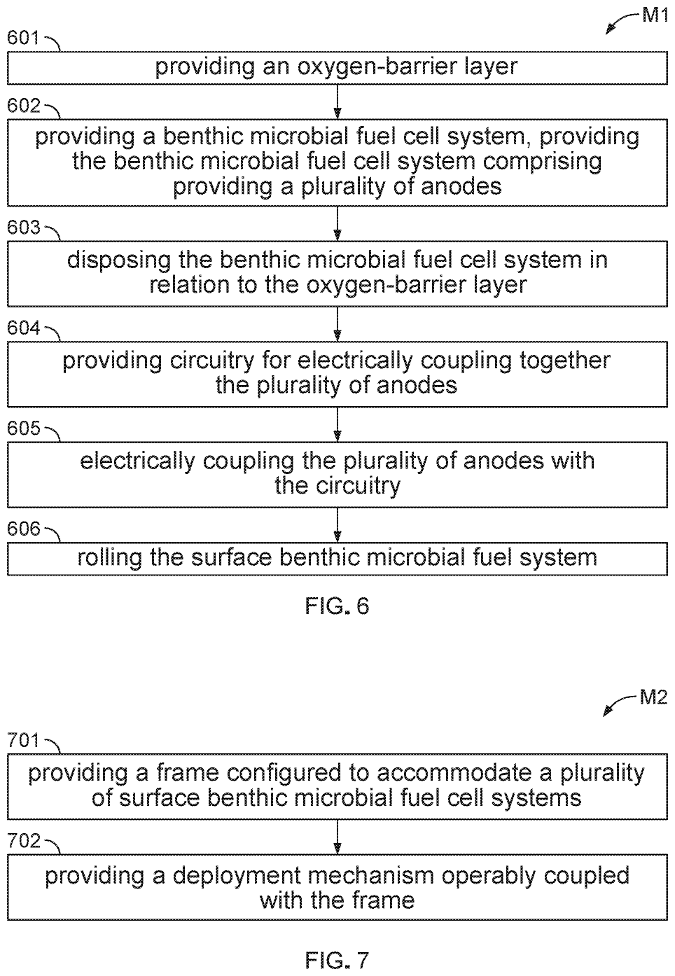

Referring to FIG. 6, this flow diagram illustrates a method M1 of fabricating an SBMFC system S, in accordance with an embodiment of the present disclosure. The method M1 comprises: providing an oxygen-barrier layer 10, as indicated by block 601; providing a BMFC system 20, as indicated by block 602, providing the BMFC system 20 comprising providing a plurality of anodes A, as indicated by block 603; and disposing the BMFC system 20 in relation to the oxygen-barrier layer 10, as indicated by block 604. The method M1 further comprises: providing circuitry for electrically coupling together the plurality of anodes, as indicated by block 605; and electrically coupling the plurality of anodes with the circuitry, as indicated by block 606. The method M1 further comprises: rolling the SBMFC system S, as indicated by block 607, thereby readying the system S for transport and disposal in relation to a deployment device 100 (FIG. 3). In the method M1, providing the BMFC system 20, as indicated by block 602, further comprises providing a corresponding plurality of cathodes C.

Referring to FIG. 7, this flow diagram illustrates a method M2 of fabricating a deployment device 100 for deploying a plurality of SBMFC systems S, in accordance with an embodiment of the present disclosure. The method M2 comprises: providing a frame F configured to accommodate a plurality of SBMFC systems S, as indicated by block 701; and providing a deployment mechanism D operably coupled with the frame F, as indicated by block 702. The method M2 further comprises: providing a retraction mechanism. In the method M2, providing the deployment mechanism D, as indicated by block 702, further comprises providing the deployment mechanism D as operable with the plurality of SBMFC systems S.

Still referring to FIG. 7, in an embodiment of the method M2, providing the deployment mechanism D comprises: providing an underwater modem, providing a battery, providing a high-pressure pump, and providing at least one hose (not shown), e.g., at least one fabric hose, coupled with each system S along a length portion thereof. Providing the at least one hose comprises configuring the at least one hose to store in a flat disposition for facilitating transport thereof as well as to roll with the system S. Providing the water pump comprises configuring the water pump activate and fill the at least one hose with high-pressure water from the aquatic environment by receiving a signal, e.g., from either the underwater modem or a tethered cord, whereby. the at least one hose becomes turgid and straightens, and whereby unrolling each system S is activated in a controllable manner, e.g., a controllable rate of unfurling.

Still referring to FIG. 7, in an embodiment of the method M2, providing the deployment mechanism D comprises providing a spring device (not shown), such as at least one of: a spring, e.g., a thin spring metal, and any other memory material configured to provide a force required for unrolling or unfurling each system S. If providing the spring device, the system S is rolled with the spring device disposed along a length portion thereof. The system S, when rolled, is stored under compression to prevent unrolling during transit thereof. Providing the deployment mechanism D of this embodiment further comprises providing a release device (not shown), such as at least one of: providing a mechanical switch and providing a burn wire, wherein the release device is activated once the system S is disposed at the sediment surface to achieve deployment thereof.

Still referring to FIG. 7, in yet another embodiment of the method M2, providing the deployment device 100 further comprise providing a retraction mechanism (not shown). Providing the deployment device 100 comprises configuring the deployment device 100 to perform at least one of: deploy and retract the plurality of SBMFC systems S, autonomously deploy and retract the plurality of SBMFC systems S, and semi-autonomously deploy and retract the plurality of SBMFC systems S. Providing the deployment device 100 further comprises configuring the deployment device 100 as scalable and configurable to accommodate more than four SBMFC systems S, whereby various power requirements for given implementations are achievable. By example only, providing the retraction mechanism comprises providing a winch (not shown) disposed at a base of the frame F for each system S. When activated, e.g., either via an acoustic modem or a timed event, the winch securely spools the systems S to the frame F for retrieval. Providing the buoyant structure, such as a buoy, comprises disposing the buoyant structure at a center of the frame F, whereby the buoyant structure is then be usable for location and retrieval of the device 100 and the systems S.

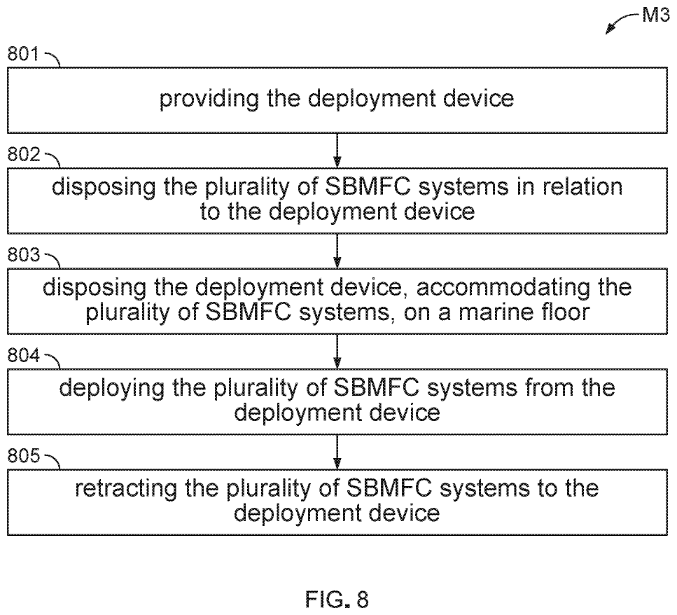

Referring to FIG. 8, this flow diagram illustrates a method M3 of deploying a plurality of SBMFC systems S by way of a deployment device 100, in accordance with an embodiment of the present disclosure. The method M3 comprises: providing the deployment device 100, as indicated by block 801; disposing the plurality of SBMFC systems S in relation to the deployment device 100, as indicated by block 802; disposing the deployment device 100, accommodating the plurality of SBMFC systems S, on a marine floor, as indicated by block 803; and 100, as indicated by block 804. The method M3 may further comprise retracting the plurality of SBMFC systems S to the deployment device 100, as indicated by block 805.

Understood is that many additional changes in the details, materials, steps and arrangement of parts, which have been herein described and illustrated to explain the nature of the invention, may be made by those skilled in the art within the principle and scope of the invention as expressed in the appended claims.

FIG. 9 is a diagram of a SBMFC system S in a deployed configuration having a flat hose 900, to be pressurized to inflate for deployment. In FIG. 9, the deployment mechanism D, having waterproof underwater housing, comprises at least one of: an underwater acoustic modem 905, a controller for data storage 910, a battery 915, a high-pressure pump 920, and at least one hose 925, such as at least one fabric hose, e.g., a pair of hoses, coupled with each system S along a length portion thereof. The at least one hose is configured to store in a flat disposition for facilitating transport thereof as well as to roll and/or unroll with the system S. By receiving a signal, e.g., from either the underwater modem or a tethered cord, the high-pressure pump 920 activates to fill the at least one hose 925 with high-pressure water from the aquatic environment. By filling the at least one hose 925 with the high-pressure water, the at least one hose 925 becomes turgid and straightens, thereby activating unrolling each system S in a controllable manner, e.g., a controllable rate of unfurling. System S also has a distribution manifold 930.

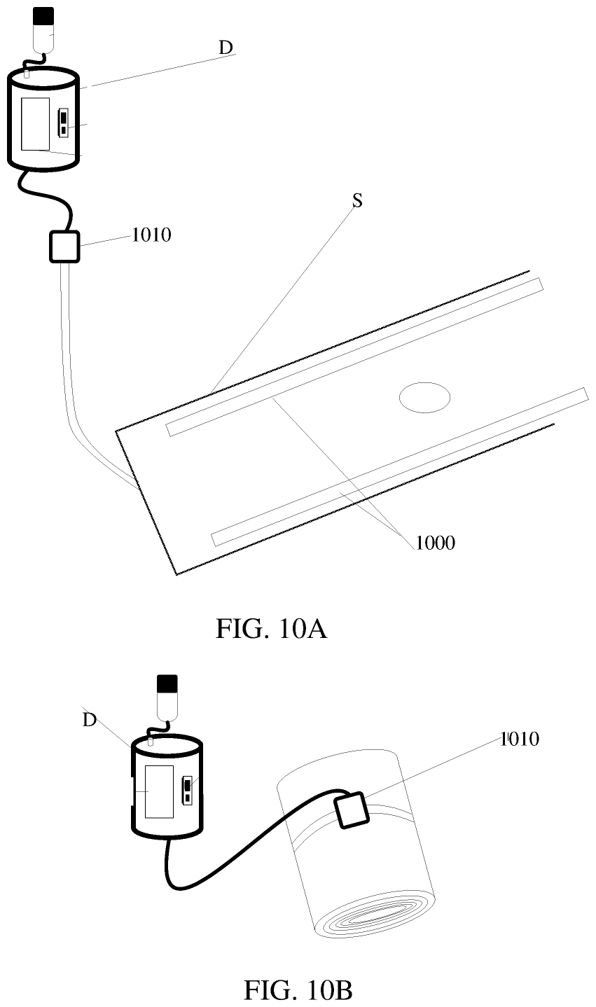

FIG. 10A is a diagram of a SBMFC system S in a deployed configuration and FIG. 10B is a diagram of a SBMFC system S in a rolled configuration. In FIGS. 10A and 10B, SBMFC system S has a spring mechanism 1000 to be used for unfurling. Spring mechanism 1000 comprises at least one of: a spring, e.g., a thin spring metal, and any other memory material configured to provide a force required for unrolling or unfurling each system S. System S is rolled with spring mechanism 1000 disposed along a length portion thereof. The system S, when rolled, is stored under compression to prevent unrolling during transit thereof. The deployment mechanism D of this embodiment further comprises a release device 1010 such as at least one of: a mechanical switch and a burn wire, wherein the release device is activated once the system S is disposed at the sediment surface to achieve deployment thereof.

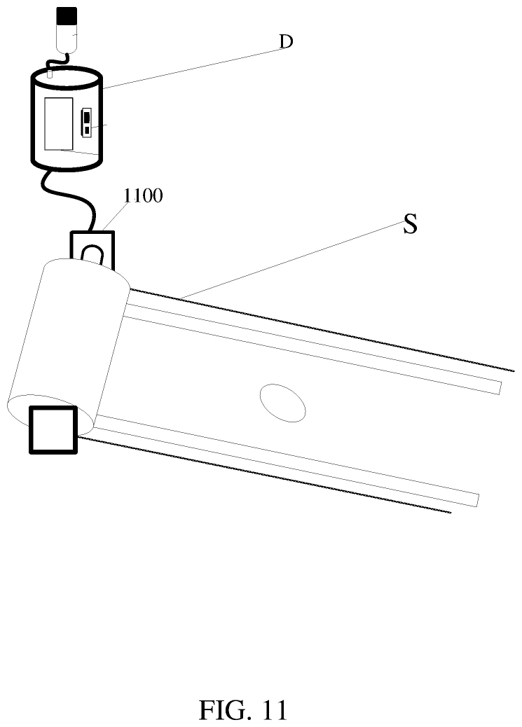

FIG. 11 shows a diagram of a SBMFC system S, wherein, the deployment device D may further comprise a retraction mechanism/winch 1100. Deployment device D is configured to perform at least one of: deploy and retract the plurality of SBMFC systems S, autonomously deploy and retract the plurality of SBMFC systems S, and semi-autonomously deploy and retract the plurality of SBMFC systems S. Deployment device D is further scalable and configurable to accommodate more than four SBMFC systems S, whereby various power requirements for given implementations are achievable. By example only, retraction mechanism/winch 1100 is disposed at a base of the frame F (shown in FIG. 5) for each system S. When activated, e.g., either via an acoustic modem or a timed event, retraction mechanism/winch 1100 securely spools the systems S to the frame F for retrieval. The buoyant structure, such as a buoy, disposed at a center of the frame F is then be usable for location and retrieval of the device 100 and the systems S.

What is claimed:

1. A deployment device, comprising:
a frame; and
a deployment mechanism operably coupled with the frame and configured to perform at least one of deploy and retract a plurality of surface benthic microbial fuel cell systems in at least one manner of manually, autonomously, and semi-autonomously.

2. The device of claim 1, wherein the frame comprises:
a plurality of horizontal members;
a plurality of vertical members, and
a plurality of curved members,
the plurality of horizontal members, the plurality of vertical members, and the plurality of curved members arranged and coupled together in any configuration that accommodates the plurality of surface benthic microbial fuel cell systems.

3. The device of claim 1, wherein the deployment mechanism comprises at least one of: an underwater modem, a battery, a high-pressure pump, and at least one hose.

4. The device of claim 1, further comprising a retraction mechanism.

5. The device of claim 4, wherein the retraction mechanism comprises a winch.

6. The device of claim 1, wherein the frame and the deployment mechanism are scalable and configurable to accommodate more than four surface benthic microbial fuel cell systems, whereby various power requirements for given implementations are achievable.

7. The device of claim 1, further comprising a surface benthic microbial fuel cell system, the surface benthic microbial fuel cell system comprising:
an oxygen-barrier layer; and
a benthic microbial fuel cell system, having a plurality of anodes, disposed in relation to the oxygen-barrier layer.

8. The device of claim 7, wherein the plurality of anodes comprises a plurality of surface anodes.

9. The device of claim 7, wherein the plurality of anodes comprises a scalable area for varying output power.

10. The device of claim 7, wherein the oxygen-barrier layer eliminates a burial requirement for the plurality of anodes.

11. The device of claim 7, wherein the benthic microbial fuel cell system further comprises a corresponding plurality of cathodes.

12. The device of claim 7, wherein the surface benthic microbial fuel cell system, comprising the benthic microbial fuel cell system disposed in relation to the oxygen-barrier layer, is configured to at least one of roll and unroll in relation to a deployment device in at least one manner of manually, autonomously, and semi-autonomously.

13. The device of claim 7,
wherein the oxygen-barrier layer comprises a plurality of oxygen-barrier layers, and
wherein the benthic microbial fuel cell system, having a plurality of anodes, disposed in relation to the oxygen-barrier layer, comprises a plurality of benthic microbial fuel cell systems, each benthic microbial fuel cell system having a plurality of anodes, and each benthic microbial fuel cell system respectively disposed in relation to the plurality of oxygen-barrier layers.

14. The device of claim 7, further comprising a circuit configured to electrically couple together the plurality of anodes.

15. The device of claim 7, wherein the oxygen-barrier layer comprises a rubber mat.

16. The device of claim 15, wherein rubber mat comprises at least one of an impermeable ethylene propylene diene rubber mat and any other oxygen-impermeable material layer.

17. The device of claim 13, wherein the plurality of benthic microbial fuel cell systems comprises an overall power output in a range of approximately 500 mW to approximately 800 mW.

18. A method of fabricating a deployment device for deploying a plurality of surface benthic microbial fuel cell systems, comprising:
providing a frame configured to accommodate a plurality of surface benthic microbial fuel cell systems; and
providing a deployment mechanism operably coupled with the frame.

19. The method of claim 18, further comprising providing a surface benthic microbial fuel cell system, providing the surface benthic microbial fuel cell system comprising:
providing an oxygen-barrier layer;
providing a benthic microbial fuel cell system, providing the benthic microbial fuel cell system comprising providing a plurality of anodes;
disposing the benthic microbial fuel cell system in relation to the oxygen-barrier layer;
providing circuitry for electrically coupling together the plurality of anodes;
electrically coupling the plurality of anodes with the circuitry; and
rolling the surface benthic microbial fuel system.

20. A method of deploying a plurality of surface benthic microbial fuel cell systems by way of a deployment device, comprising:
providing the deployment device;
disposing the plurality of surface benthic microbial fuel cell systems in relation to the deployment device;
disposing the deployment device, accommodating the plurality of surface benthic microbial fuel cell systems, on a marine floor; and
deploying the plurality of surface benthic microbial fuel cell systems from the deployment device.
